(19) United States
(12) Patent Application Publication
(10) Pub. No.: US 2026/0363834 A1
(43) Pub. Date: Nov. 19, 2026

(54) Apparatus and method for dental driver

(71) Applicant: Christopher Barrett, Scottsdale, AZ (US)

(72) Inventor: Christopher Barrett, Scottsdale, AZ (US)

(21) Appl. No.: 18/445,163

(22) Filed: May 4, 2023

(51) Int. Cl. A61C 8/00

(52) U.S. Cl. CPC A61C 8/0089

(57) ABSTRACT

A dental driver includes a head, a linkage, and a handle. The linkage may include a redirection joint to translate rotational motion from around the axis of the handle to around a different axis in order to provide easier access to a patient's mouth.

### BACKGROUND

Inventive concepts relate generally to an apparatus and method for a driver that may be employed in dental implant surgery. In particular, inventive concepts relate to an apparatus and method that provide improved control of the dental implant procedure.

Dental implants restore the oral function and facial form of individuals who, through disease, accident, or other unfortunate circumstances, have lost one or more of their teeth. Dental implants have been employed to improve not only the appearance but also the health of millions of people throughout the world. Nearly five million dental implants are placed each year in the United States alone.

There are some indications that implants were used hundreds, if not thousands, of years ago, with evidence, for example, of the Mayans of Central America successfully implanting tooth-shaped shells in a person's jaw; bone regeneration around the shells evidences a successful outcome. The modern dental implant process appears to have been enabled in the early 1950s by an orthopedic surgeon's recognition that titanium may be a promising implant material. The surgeon had placed a titanium cylinder on a rabbit's femur and, when he attempted to remove it, he saw that the cylinder had fused with the rabbit's bone. The same surgeon applied that knowledge to successfully install a titanium dental implant into the jaw of a volunteer.

The dental implantation process may generally follow a process whereby, in preliminary steps, an extraction may be performed if there is an impacted, broken, or damaged tooth to be replaced. A bone graft may be required if the jaw lacks the strength to support the implant. The patient's gum may then be cut to expose the jawbone and a hole drilled into the jawbone for insertion of a threaded post. The post is of a biocompatible material, such as titanium, and it is inserted, for example, by screwing it into the drilled hole. Time is allowed for osseointegration, the process of bone growth that integrates the post into the jaw. When the post has sufficiently integrated with the jawbone, the patient's gum may be reopened, an abutment placed on the dental post and a crown placed on the abutment. The exploded view of FIG. 1A provides a general illustration of the completed process, with post 100 implanted in a patient's upper jaw/maxilla 102 and a crown 104 affixed to abutment 106, which is, in turn, affixed to post 100. FIG. 1B illustrates various types of dental post: tapered smooth 108, parallel serrated 110, parallel self-threading 112, parallel threaded, and parallel serrated threaded end 116. Posts generally are engaged at their proximal/tip (“non jaw”) end with a driver tip that allows a surgeon to turn and thereby seat the post within a patient's jaw. As will be described in greater detail in the discussion related to FIGS. 3A-3K, different posts may require different types of driver tips. That is, the inside of a post's proximal/tip end may be configured to engage with a specific type of driver tip.

A tool 120 commonly used to implant a post 100 in a patient's jaw, referred to as a dental screwdriver or dental driver, is illustrated in FIG. 2A. As the name suggests, the dental screwdriver 200 is used to screw post 100 into a patient's jaw. Typically, the dental screwdriver includes a tip, which, at a distal/post end, is formed to engage and turn a post. At a proximal/tool end, the tip is configured to be secured to the dental screwdriver. A variety of tips are in use, with post-end configurations including: a variety of hex, star, flat bladed, triangle, torx, slot, square, quads and lobes, for example. The tips' proximal/tool ends also come in a variety of configurations, typically, to engage with different manufacturers' handles. The tool 120 includes a handle, or gripping region, 122, a shaft 124, and a tip engagement means 126, which is often, as in this example, a type of socket. FIG. 2B illustrates the socket interior of tip engagement means 126.

FIGS. 3A through 3K illustrate a variety of dental driver tip types, each compatible with a specific type of dental post. That is, each of the tips is configured for engagement with a specific post type's proximal/tip end, whether it be hex, square, flat, etc. Additionally, each tip, at its tool end, is configured for engagement with a specific type of tool, at the tool's engagement end (e.g., socket). The tip 300 of FIG. 3A features a Hex post engagement end 302 and a driver engagement end 304 that includes an Q-ring 306 situated between two substantially cubical bodies 305a, 305b. The driver engagement end 304 is configured for coupling with a specific driver socket type. The tip of FIG. 3B also features a hex post engagement end 308 with a driver engagement end 310 that is different from that of 304, as it is configured for coupling to a different type of driver socket. The tip 312 of FIG. 3C features a “star” post engagement end 314, that of FIG. 3D features a flat blade engagement end 316, that of FIG. 3E features another type of hex end 318, that of FIG. 3F features a square post engagement end 320, that of FIG. 3G features an “ITI” end 322, that of 3H features a triangle post engagement end 324, that of FIG. 31 features a another type of hex 326, that of FIG. 3J another square post engagement end 328, and that of FIG. 3K another type of hex post engagement end 330.

Because, even with a widely opened mouth, the opposing part of a patient's jaw, and associated teeth, interfere with access to the patient's mouth, it is often difficult for a surgeon to properly position a dental driver for accurate, controlled driving of a post into the patient's jaw.

### SUMMARY OF THE INVENTION

In example embodiments in accordance with principles of inventive concepts a dental driver includes a handle, a drive-head, or, simply, head, and a linkage connecting the two. The linkage may include a re-direction joint. The redirection joint may be fixed-angle or flexible angle. A fixed-angle redirection joint may employ a bevel gear set, for example. A flexible angle redirection joint may employ a universal joint or a constant velocity joint, for example. The head may be configured to include or engage a dental post implant tip. In some embodiments a ratchet may be included in the handle, in the linkage, or in the head. In some embodiments the head may include a direction joint. In some embodiments the head may include a mating member, sometimes referred to herein as a square drive, configured to join with interchangeable sockets, each of which may be configured to mate with and drive a particular type of dental post tip. Square drives are known male/female connection fittings that are available in a variety of sizes and, in example embodiments, a square drive may be chosen to readily fit within a patient's open mouth. In example embodiments a tool in accordance with principles of inventive concepts may employ a square drive that includes a through hole (with a retaining ring and pin or single piece molded retaining ring), a locking pin, or a friction ball, for example, to attach a socket to the dental post driver.

In example embodiments, a dental driver tool may include a handle; a linkage; and a head configured and arranged for mating engagement with a tool end of a dental post driver tip, wherein the linkage couples the handle to the head and the linkage includes a redirection joint configured and arranged to enable the redirection of rotational motion imparted to the handle from around the axis of the handle to around a different axis.

In example embodiments, a dental driver tool may include a redirection joint that is a fixed redirection joint.

In example embodiments, a dental driver tool may include a redirection joint that is a flexible redirection joint.

In example embodiments, a dental driver tool may include a redirection joint comprises a universal joint.

In example embodiments, a dental driver tool may include a redirection joint that comprises a constant velocity joint.

In example embodiments, a dental driver tool may include a head that comprises a socket for mating engagement with a tool end of a dental post driver tip.

In example embodiments, a dental driver tool may include a head that comprises a square drive configured and arranged for mating with a socket.

In example embodiments, a dental driver tool may include a socket configured and arranged for mating with a dental post driver tip.

In example embodiments, a dental driver tool may include a socket configured and arranged for mating with a dental abutment driver tip.

In example embodiments, a dental driver tool may include a head that comprises a redirection joint.

In example embodiments, a dental driver tool may include a head redirection joint that comprises a fixed redirection joint.

In example embodiments, a dental driver tool may include a head redirection joint that comprises a bevel gear set.

In example embodiments, a dental driver tool may include a ratchet configured and arranged to allow rotation of a socket in only one direction.

In example embodiments, a dental driver tool may include a handle; a linkage; and a head with a socket configured and arranged for mating engagement with a tool end of a dental post driver tip, wherein the linkage couples the handle to the head and the linkage includes a universal joint configured and arranged to enable the redirection of rotational motion imparted to the handle from around the axis of the handle to around a different axis.

In example embodiments, a dental driver tool may include a bevel gear set in the head configured to redirect rotational motion.

In example embodiments, a dental driver tool may include a ratchet configured and arranged to allow rotational motion in only one direction around an axis.

In example embodiments, a dental driver tool may include a ratchet included within the handle.

In example embodiments, a method of driving a dental implant post, includes a linkage translating rotational motion of a handle from around the axis of the handle to around a different axis; and the linkage driving a head configured and arranged to couple to a dental post driver tip.

In example embodiments, a method of driving a dental implant post, includes a linkage translating rotational motion through a fixed redirection joint.

In example embodiments, a method of driving a dental implant post, includes a linkage translating rotational motion through a flexible redirection joint.

### BRIEF DESCRIPTION OF THE DRAWINGS

Example embodiments in accordance with principles of inventive concepts will be more clearly understood from the following detailed description taken in conjunction with the accompanying drawings in which:

FIG. 1A is view of dental implant components including post, abutment, and crown;

FIG. 1B is a view of various dental implant posts;

FIG. 2A is a view of a conventional dental post driver;

FIG. 2B is a view of the socket end of the dental post driver of FIG. 2A;

FIGS. 3A through 3K are views of various dental post tips;

FIG. 4 is a block diagram of a dental post driver in accordance with principles of inventive concepts;

FIGS. 5A through 5D are views of various handles such as might be employed in a dental post driver in accordance with principles of inventive concepts;

FIGS. 6A through 6E are views of various redirection joints such as might be employed in a dental post driver in accordance with principles of inventive concepts;

FIGS. 7A and 7B are views of bevel gear sets such as might be employed in a dental post driver in accordance with principles of inventive concepts;

FIG. 8 is a schematic view of a ratchet such as might be employed in a dental post driver in accordance with principles of inventive concepts; and

FIG. 9 is a view of an example embodiment of a dental post driver in accordance with principles of inventive concepts.

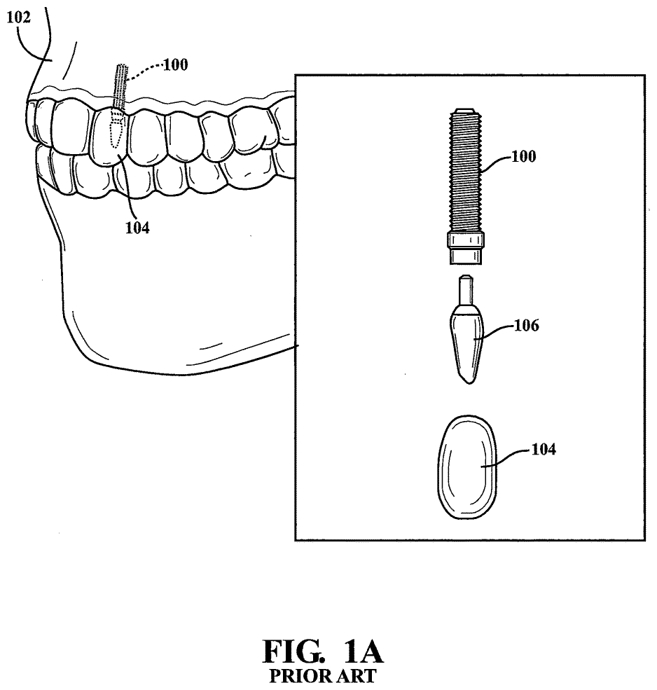

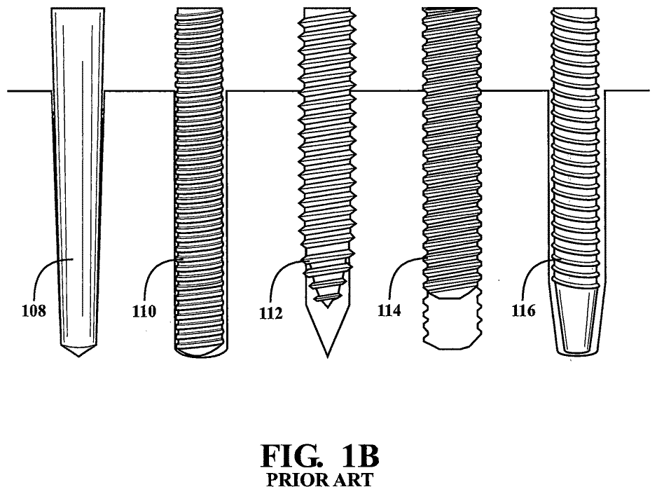

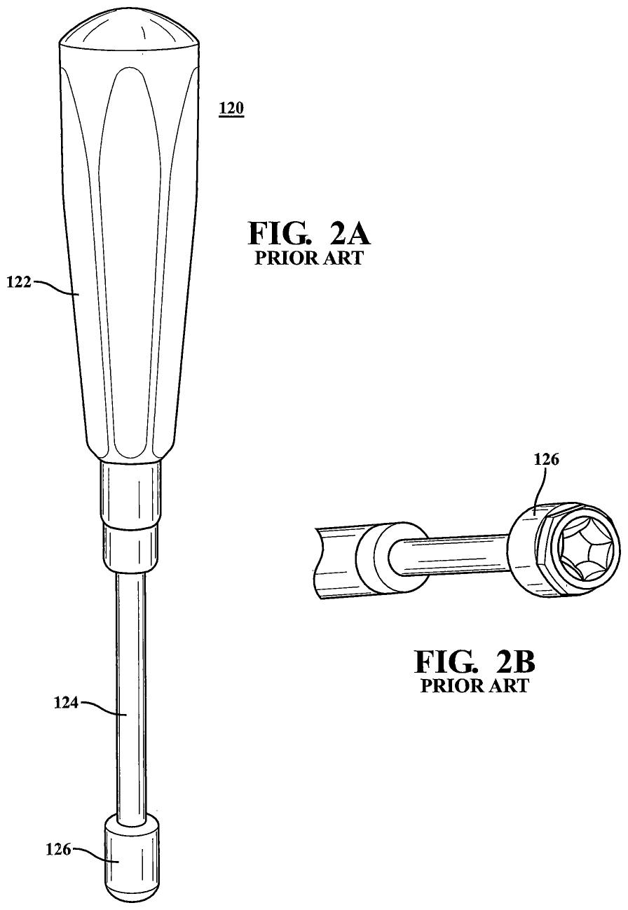

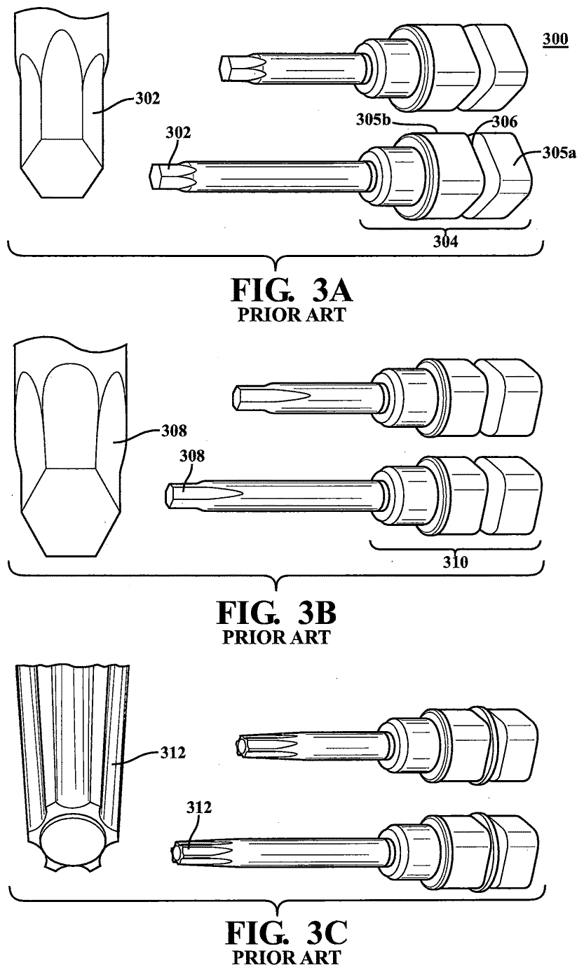

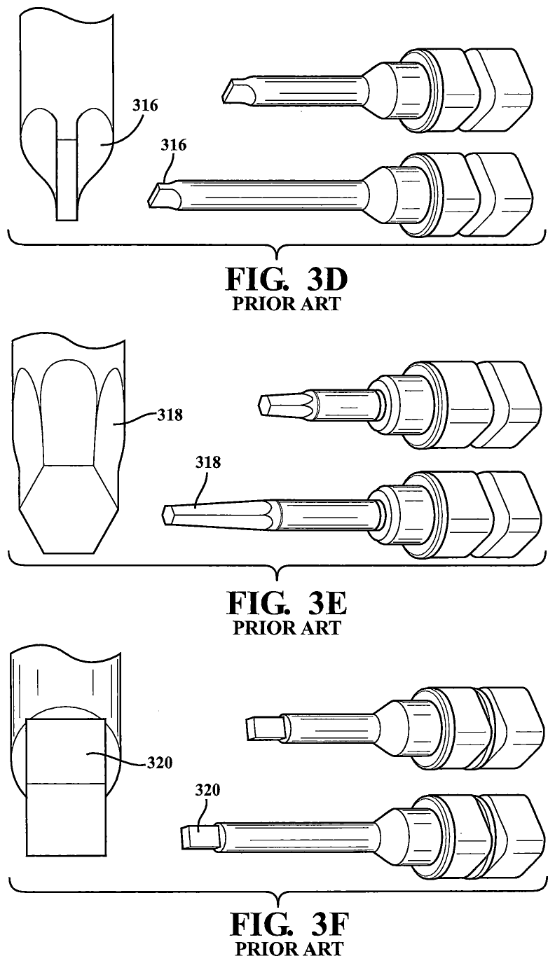

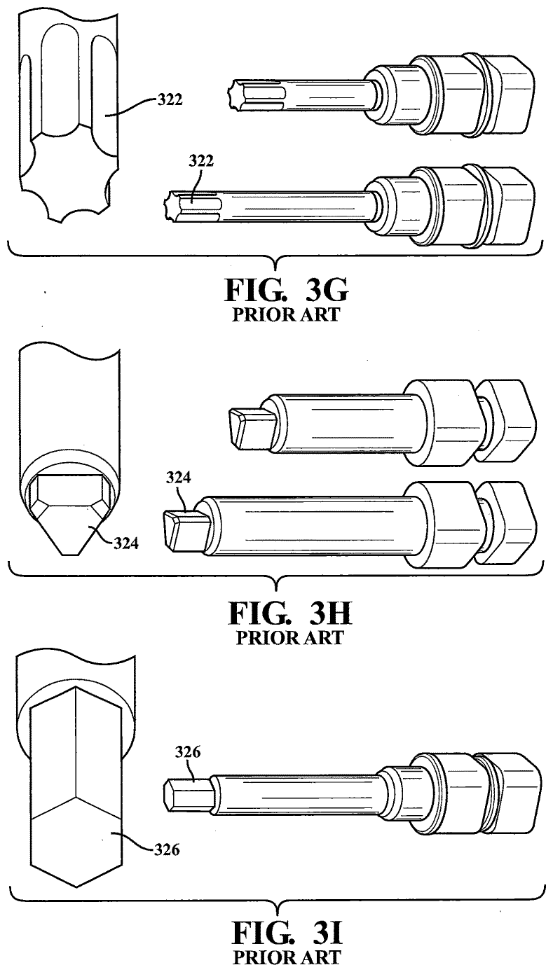

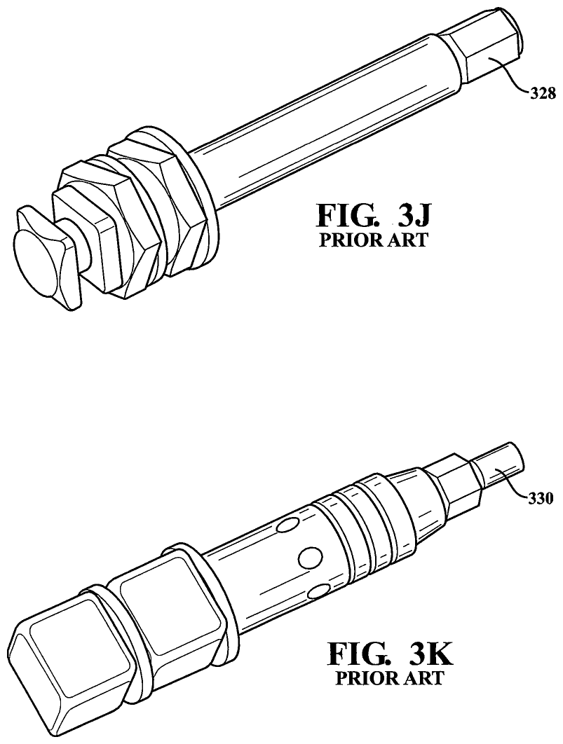

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated. Example embodiments of systems and methods in accordance with principles of inventive concepts will be described in reference to the accompanying drawings and, although the phrase “example embodiments in accordance with principles of inventive concepts” may be used occasionally, for clarity and brevity of discussion example embodiments may also be referred to as “Applicants' system,” “the system,” “Applicants' method,” “the method,” or, simply, as a named component or element of a system or method, with the understanding that all are merely example embodiments of inventive concepts in accordance with principles of inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers or sections, these elements, components, regions, layers or sections should not be limited by these terms. These terms are only used to distinguish one element, component, region, step, layer or section from another element, component, region, step, layer or section. Thus, a first element, component, region, step, layer or section discussed below could be termed a second element, component, region, step, layer or section without departing from the teachings of example embodiments.

Spatially relative terms, such as “beneath,” “below,” “lower,” “above,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” or “including,” if used herein, specify the presence of stated features, integers, steps, operations, elements or components, but do not preclude the presence or addition of one or more other features, integers, steps, operations, elements, components or groups thereof. The word “or” is used in an inclusive sense to mean both “or” and “and/or.” The term “exclusive or” will be used to indicate that only one thing or another, not both, is being referred to.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In example embodiments a dental driver in accordance with principles of inventive concepts may comprise a handle, a linkage, and a head. The linkage may include a re-direction joint. The redirection joint may be fixed-angle or flexible angle. A fixed-angle redirection joint may employ a bevel gear set, for example. A flexible angle redirection joint may employ a universal joint or a constant velocity joint, for example. The head may be configured to include or engage a dental post implant tip. In some embodiments a ratchet may be included in the handle, in the linkage, or in the head. In some embodiments the head may include a direction joint. In some embodiments the head may include a mating member, sometimes referred to herein as a square drive, configured to join with interchangeable sockets, each of which may be configured to mate with and drive a particular type of dental post tip. Square drives are known male/female connection fittings that are available in a variety of sizes and, in example embodiments, a square drive may be chosen to readily fit within a patient's open mouth. In example embodiments a tool in accordance with principles of inventive concepts may employ a square drive that includes a through hole (with a retaining ring and pin or single piece molded retaining ring), a locking pin, or a friction ball, for example, to attach a socket to the dental post driver.

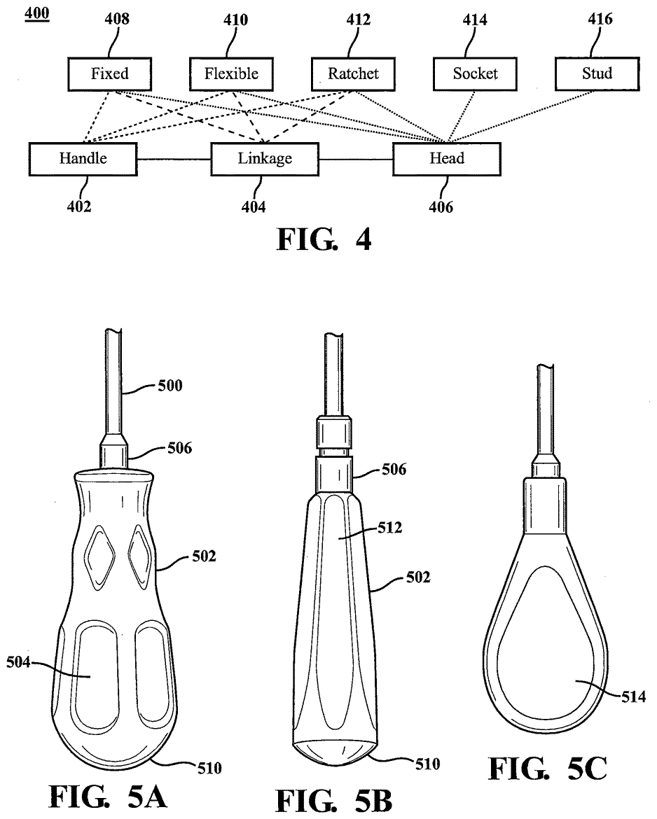

Turning now to the block diagram of FIG. 4, a dental post driver 400 in accordance with principles of inventive concepts may include a handle 402, a linkage 404, and a head, or driver head, 406. In example embodiments components of dental post driver 400 may be composed of materials such as aluminum, stainless steel, or dense silicon rubber, for example, that may be readily cleaned in an autoclave. As will be described in greater detail in the discussion related to the following figures, the handle 402 may include a gripping section and a shaft section, with the gripping section contoured for secure gripping. The linkage 404 may include a flexible 410 or fixed 408 redirection joint. The head 406 may include a dedicated socket 414 configured to engage a single style of dental post tips or may include a mating member, or square drive 416, configured to engage interchangeable sockets, thus allowing the tool 400 to operate with a wide variety of dental post driver tips. A fixed 408 or flexible 410 redirection joint may be included in the head 406 to provide enhanced access to a patient's open mouth. A ratchet 412 may be included in the handle 402, the linkage 404, or the head 406, to allow a surgeon to retain a grip on the tool while screwing a dental post into a patient's jaw. In example embodiments a fixed redirection joint 408 may comprise a bevel gear set. In example embodiments a flexible redirection joint 410 may comprise a universal joint or constant velocity joint.

In example embodiments a dental driver tool in accordance with principles of inventive concepts may include a handle that features a gripping area and a shaft. The handle may be made of a material suitable for cleaning in an autoclave and may be shaped to provide a secure grip in a surgeon's hand. To that end, the handle gripping region may include ridges, scalloping, knurling or other grip-enhancing features and may be of a size and shape that fits securely within a surgeons' hand. The overall contour of the handle may be such that it starts from a narrower width at the linkage end (the end gripped by thumb and index finger), widens towards the middle to fit the surgeon's palm and narrows again at the tip where the fifth digit and palm grip the handle. In example embodiments the handle grip may be between 2 and 6 inches in length. In other example embodiments the handle grip may be between 3 and 5 inches in length. In other example embodiments the handle grip may be between 3.5 and 4.5 inches in length. In example embodiments, the handle grip may be between 0.25 and 1.75 inches in diameter at the linkage end; in other example embodiments the handle grip may be between 0.5 and 1.5 inches in diameter at the linkage end, and in other example embodiments the handle grip may be between 0.075 and 1.25 inches in diameter at the linkage end. In example embodiments, the handle grip may be between 0.25 and 3.75 inches in diameter in the middle of the grip region; in other example embodiments the handle grip may be between 1.0 and 3.0 inches in diameter in the middle of the grip region, and in other example embodiments the handle grip may be between 1.25 and 2.50 inches in diameter in the middle of the grip region. In example embodiments, the handle grip may be between 0.25 and 3.25 inches in diameter at the fifth digit end; in other example embodiments the handle grip may be between 0.5 and 2.5 inches in diameter at the fifth digit end, and in other example embodiments the handle grip may be between 1.0 and 2.0 inches in diameter at the fifth digit end.

In example embodiments, the gripping area of the handle may include three or more flat sides that, at their junctures form ridges that enhance gripping. In example embodiments the gripping area of the handles may be substantially cylindrical (optionally, with a ballooning middle) with regions “scooped out” to form a scalloping effect, with the ridges and valleys thereby formed to, again, enhance gripping performance. In some embodiments a gripping sleave, formed of a soft rubbery material may be configured for permanent or detachable attachment to the gripping area for enhanced gripping performance.

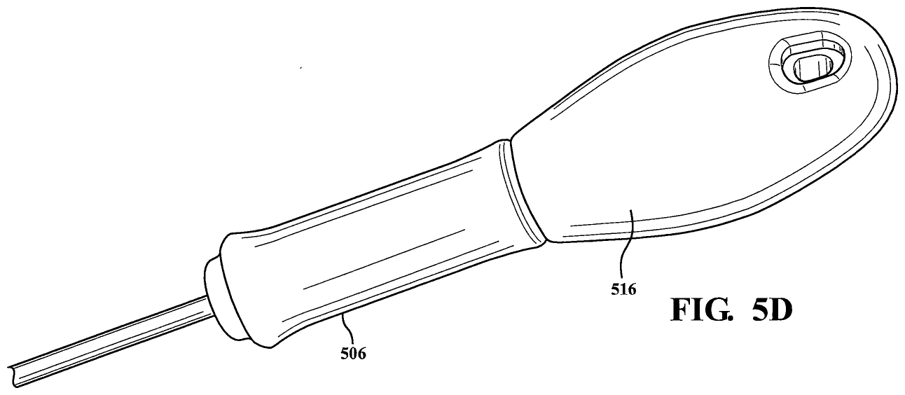

Example embodiments of handles that a dental driver tool in accordance with principles of inventive concepts may employ are illustrated in FIGS. 5A through 5D. The handle of FIG. 5A includes shaft 500 and grip 502. Indentations, or scalloped features 504 enhance a person's grip security while holding the handle. In this example embodiment, the grip 502 is approximately one inch in diameter at its linkage end 506 and 2.5 inched in diameter at the middle 508- and fifth-digit end 510. In the example embodiment of FIG. 5B the grip region 502 features a hexagonal cross-section, with ridges 512 to enhance grip security. In this example embodiment the grip region may be approximately 1 inch in diameter at linkage end 506 and 2 inches in diameter at fifth digit end 510. In the example embodiment of FIG. 5C a grip may feature a substantially bulbous conformation with flattened sides 514 formed to enhance grip security. The handle of FIG. 5D includes a region of relatively uniform width at its linkage end 506, which expands into a bulbous region 516 configured to conform to a surgeon's closed palm. The grip region terminates in a rounded fifth-digit end.

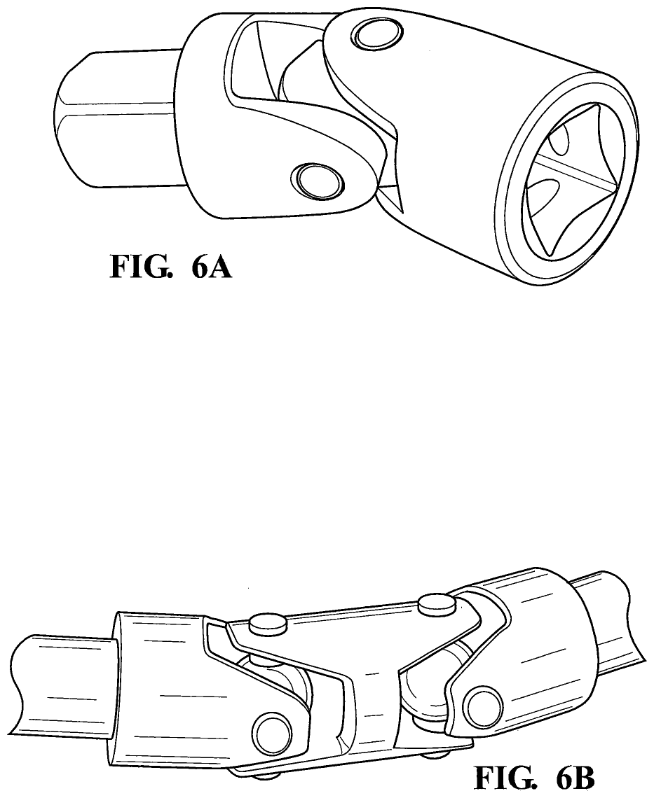

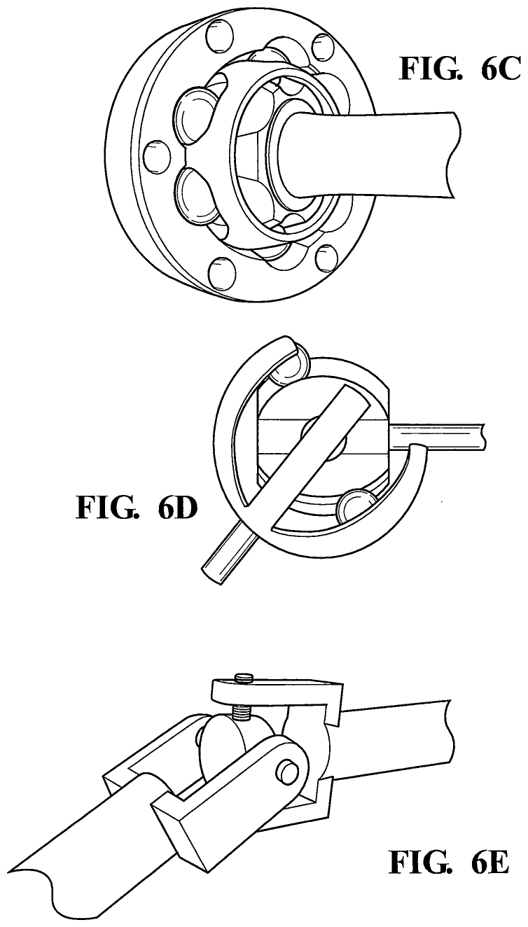

In example embodiments a linkage may connect handle 402 to head 406. in example embodiments linkage 404 may include a redirection joint that flexibly or fixedly transfers rotational motion of handle 402 from along a first axis (imparted, for example, by the twisting motion of a surgeon's hand) to rotational motion along a different axis, thereby allowing for better alignment of rotational motion with the longitudinal axis of a dental post being placed in a patient's jaw. In example embodiments a bevel gear set may be employed in a linkage in accordance with principles of inventive concepts to fixedly transfer rotational motion from around the axis of the handle to around different axis. In example embodiments a linkage may include a fixed (including e.g., a bevel gear set) or flexible (including a universal or constant velocity joint) redirection joint, to transfer rotational motion from around the axis of a handle to an intermediate axis and to engage another redirection joint (fixed or flexible) within the tool head 406, which is compact enough to readily fit within a patient's open mouth. In example embodiments a second redirection joint within the head 406 may transfer rotational motion from around an intermediate axis to an axis more readily aligned with the axis of a dental post being implanted. FIGS. 6A through 6E illustrate some joint types that may be employed in a linkage 404 in accordance with principles of inventive concepts. As previously noted, linkage 404 may include a fixed redirection joint, such as one including a bevel gear set, or a flexible redirection joint such as an universal joint or constant velocity joint, for example. Constant velocity joints are known and may include: Tracta joint, Rzeppa joint, Birfield joint, Weiss joint, double cardan joint, Thompson joint, or Malpezzi joint, for example. Examples of universal joint are included inf FIGS. 6A and 6E. A Double Cardan joint is illustrated in FIG. 6B, a Rzeppa joint is illustrated in FIGS. 6C and 6D.

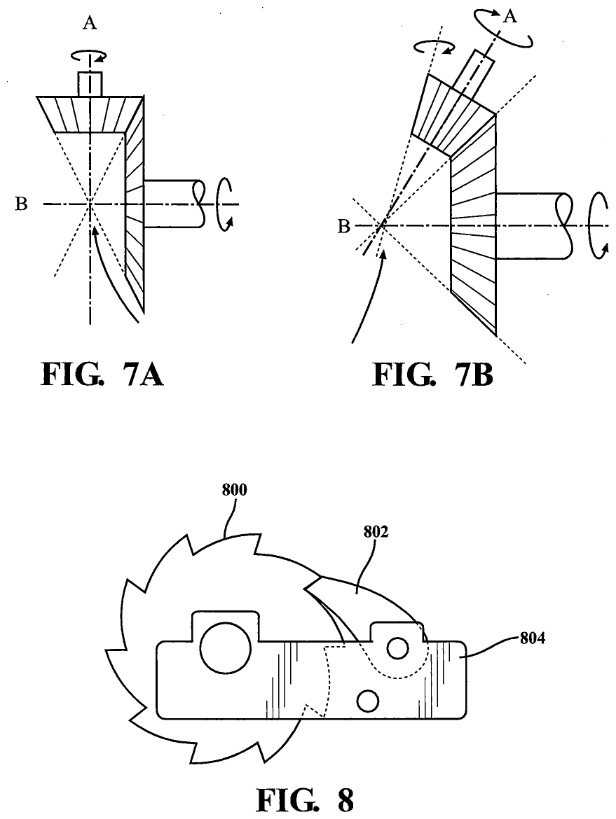

FIGS. 7A and 7B illustrate bevel gear sets such as may be employed in a dental driver tool 400 in accordance with principles of inventive concepts. Bevel gear sets are known devices configured to redirect rotational motion from around one axis to around another. As may be seen in the example embodiments of FIGS. 7A and 7B, the redirection angle (90 degrees in FIG. 7A, approximately 85 degrees in FIG. 7B) may be any of a variety of fixed angles. A bevel gear set may be employed in example embodiments in the linkage 404 or head 406 to configure the tool 400 for better access to a patient's open mouth. In the example embodiments of FIGS. 7A and 7B, rotational motion around axis B (generated by the turning of a handle by a surgeon, for example) is converted to rotational motion around axis A.

A dental tool in accordance with principles of inventive concepts may include a ratchet to assist a surgeon while the surgeon is driving an implant post. Ratchets are known and the basic components of a ratchet are illustrated in FIG. 8. A pivoting spring-loaded pawl 802 allows a toothed gear 800 to freely rotate in one direction (counterclockwise in this example), while, through engagement with the gear's teeth, preventing rotation in the opposite direction. To prevent backlash, a high friction surface, such as rubber, may be substituted for the gear. In such embodiments, rotary motion is allowed in one direction and rotary motion in the opposite direction is blocked by the pawl's jamming against the surface of the high friction surface (e.g., rubber). In example embodiments a ratchet may be employed in the handle 402, the linkage 404, or head 406, of a dental tool 400 in accordance with principles of inventive concepts.

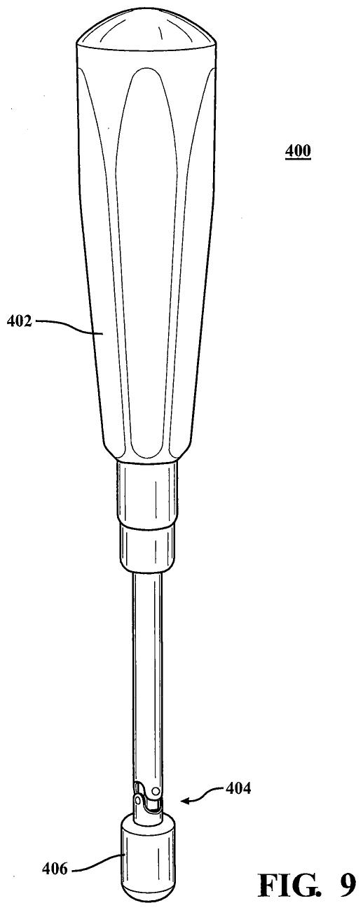

In the example embodiment of FIG. 9 a dental driver tool 400 in accordance with principles of inventive concepts includes handle 402, linkage 404, and head 406. In this example embodiment linkage 404 comprises a universal joint, as illustrated. Head 406 includes a socket configured and arranged to drive a dental post tip. As described in the discussions related to previous Figs., in example embodiments, the gripping area of the handle may include three or more flat sides that, at their junctures form ridges that enhance gripping. In example embodiments the gripping area of the handles may be substantially cylindrical (optionally, with a ballooning middle) with regions “scooped out” to form a scalloping effect, with the ridges and valleys thereby formed to, again, enhance gripping performance. In some embodiments a gripping sleave, formed of a soft rubbery material may be configured for permanent or detachable attachment to the gripping area for enhanced gripping performance.

In example embodiments a linkage may connect handle 402 to head 406. in example embodiments linkage 404 may include a redirection joint that flexibly (comprising a universal or constant velocity joint, for example) or fixedly (comprising a bevel gear set, for example) transfers rotational motion of handle 402 from along a first axis (imparted, for example, by the twisting motion of a surgeon's hand) to rotational motion along a different axis, thereby allowing for better alignment of rotational motion with the longitudinal axis of a dental post being placed in a patient's jaw. In example embodiments a bevel gear set may be employed in a linkage in accordance with principles of inventive concepts to fixedly transfer rotational motion from around the axis of the handle to around different axis. In example embodiments a linkage may include a fixed (including e.g., a bevel gear set) or flexible (including a universal or constant velocity joint) redirection joint, to transfer rotational motion from around the axis of a handle to an intermediate axis and to engage another redirection joint (fixed or flexible) within the tool head 406, which is compact enough to readily fit within a patient's open mouth. In example embodiments a second redirection joint within the head 406 may transfer rotational motion from around an intermediate axis to an axis more readily aligned with the axis of a dental post being implanted. Sleeves, casings, or other coverings for shafts, joints, ratchets or other components of a dental driver tool are contemplated within the scope of inventive concepts.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims.

What is claimed is:

1. A dental driver tool, comprising:
a handle;
a linkage; and
a head configured and arranged for mating engagement with a tool end of a dental post driver tip, wherein the linkage couples the handle to the head and the linkage includes a redirection joint configured and arranged to enable the redirection of rotational motion imparted to the handle from around the axis of the handle to around a different axis.

2. The dental driver tool of claim 1, wherein the redirection joint is a fixed redirection joint.

3. The dental driver tool of claim 1, wherein the redirection joint is a flexible redirection joint.

4. The dental driver tool of claim 3, wherein the redirection joint comprises a universal joint.

5. The dental driver tool of claim 3, wherein the redirection joint comprises a constant velocity joint.

6. The dental driver tool of claim 1, wherein the head comprises a socket for mating engagement with a tool end of a dental post driver tip.

7. The dental driver tool of claim 1, wherein the head comprises a square drive configured and arranged for mating with a socket.

8. The dental driver tool of claim 1, wherein the socket is configured and arranged for mating with a dental post driver tip.

9. The dental driver tool of claim 1, wherein the socket is configured and arranged for mating with a dental abutment driver tip.

10. The dental driver tool of claim 1, wherein the head comprises a redirection joint.

11. The dental driver tool of claim 10, wherein the head redirection joint comprises a fixed redirection joint.

12. The dental driver tool of claim 11, wherein the head redirection joint comprises a bevel gear set.

13. The dental driver tool of claim 1, further comprising a ratchet configured and arranged to allow rotation of a socket in only one direction.

14. A dental driver tool, comprising:
a handle;
a linkage; and
a head with a socket configured and arranged for mating engagement with a tool end of a dental post driver tip, wherein the linkage couples the handle to the head and the linkage includes a universal joint configured and arranged to enable the redirection of rotational motion imparted to the handle from around the axis of the handle to around a different axis.

15. The dental driver tool of claim 14, further comprising a bevel gear set in the head configured to redirect rotational motion.

16. The dental driver tool of claim 14, further comprising a ratchet configured and arranged to allow rotational motion in only one direction around an axis.

17. The dental driver tool of claim 16, wherein the ratchet is included within the handle.

18. A method of driving a dental implant post, comprising:
a linkage translating rotational motion of a handle from around the axis of the handle to around a different axis; and
the linkage driving a head configured and arranged to couple to a dental post driver tip.

19. The method of driving a dental implant post of claim 18, wherein the linkage translates rotational motion through a fixed joint.

20. The method of driving a dental implant post of claim 18, wherein the linkage translates rotational motion through a flexible joint.
